(19) United States
(12) Patent Application Publication
(10) Pub. No.: US 2015/0022768 A1
(43) Pub. Date: Jan. 22, 2015

(54) OPTOELECTRONIC DEVICE

(71) Applicant: Chung-Yin Li, Taichung City (TW)

(72) Inventor: Chung-Yin Li, Taichung City (TW)

(73) Assignee: WINTEK CORPORATION, Taichung City (TW)

(21) Appl. No.: 14/159,462

(22) Filed: Jan. 21, 2014

(30) Foreign Application Priority Data
Jul. 16, 2013 (TW) 102125444

(51) Int. Cl. G02F 1/1343; G02F 1/1335; G02F 1/1337

(52) U.S. Cl. CPC G02F 1/134309; G02F 1/1337; G02F 1/133514; G02F 2001/133773
USPC 349/108; 349/141; 349/128

(57) ABSTRACT

An optoelectronic device includes a first substrate and a second substrate opposite to each other, a display medium between the first substrate and the second substrate, multiple first driving electrodes between the display medium and the first substrate, multiple second driving electrodes between the display medium and the first substrate, multiple common electrodes between the display medium and the second substrate and multiple adjusting electrodes between the display medium and the second substrate wherein the second and first driving electrodes, and the adjusting electrodes and the common electrodes are respectively arranged alternately. The adjusting electrodes and the common electrodes, and the two kinds of driving electrodes are respectively electrically insulated from each other. The normal projections of one of the first driving electrodes, one of the adjusting electrodes and one of the second driving electrodes on the second substrate are sequentially arranged between two adjacent common electrodes.

### CROSS-REFERENCE TO RELATED APPLICATION

This application claims the priority benefit of Taiwan application serial no. 102125444, filed on Jul. 16, 2013. The entirety of the above-mentioned patent application is hereby incorporated by reference herein and made a part of this specification.

### BACKGROUND OF THE INVENTION

1. Field of the Invention

The invention generally relates to an optoelectronic device, and more particularly, to an adjustable optoelectronic device.

2. Description of Related Art

For many applications, a mono-view display or a planar-view display is unable to meet the needs of the users today. Taking an example, for vehicle displays, the user requires a display with multiple views available for the driver and passenger to simultaneously watch respectively desired frames such as a navigation frame and a movie frame for the respective needs of the driver and passenger. In the visual entertainment, the user needs a stereoscopic display so as to increase an immersive virtual effect.

In general, the above-mentioned display includes a display panel and optoelectronic devices plugged-in onto the display panel. The optoelectronic device can guide the light emitted from the display panel to different directions or view domains to achieve multi view effect or stereoscopic view effect. Such optoelectronic device mainly has two types: optoelectronic device in parallax barrier type and optoelectronic device in lenticular lens type, wherein the optoelectronic device in parallax barrier type takes advantage of the blocking function of a barrier to restrict the displaying light emitting towards a specific direction so as to achieve multi view effect or stereoscopic view effect, while the optoelectronic device in lenticular lens type takes advantage of multiple lenticulars to change the projection angles of light so as to achieve multi view effect or stereoscopic view effect.

### SUMMARY OF THE INVENTION

Accordingly, the invention is directed to an optoelectronic device able to adjust the light emitting direction.

An optoelectronic device of the invention includes a first substrate, a second substrate opposite to the first substrate, a display medium located between the first substrate and the second substrate, a plurality of first driving electrodes located between the display medium and the first substrate, a plurality of second driving electrodes located between the display medium and the first substrate, a plurality of common electrodes located between the display medium and the second substrate and a plurality of adjusting electrodes located between the display medium and the second substrate in which the second driving electrodes and the first driving electrodes are arranged alternately, and the adjusting electrodes and the common electrodes are arranged alternately. The adjusting electrodes and the common electrodes are electrically insulated from each other and the first driving electrodes and the second driving electrodes are electrically insulated from each other. The normal projections of one of the first driving electrodes, one of the adjusting electrodes and one of the second driving electrodes on the second substrate are sequentially arranged between two adjacent ones of the common electrodes.

In an embodiment of the invention, the above-mentioned two adjacent common electrodes, the one of the first driving electrodes, the one of the adjusting electrodes and the one of the second driving electrodes together form a light-adjusting unit.

In an embodiment of the invention, the adjacent two common electrodes are configured to be applied by a constant voltage, in which the one of the first driving electrodes is configured to be applied by a first driving voltage, the one of the second driving electrodes is configured to be applied by a second driving voltage, the one of the adjusting electrodes is configured to be applied by an adjusting voltage, and the adjusting voltage is obtained by the sum of the first driving voltage and the second driving voltage minus the constant voltage.

In an embodiment of the invention, the adjacent two common electrodes are configured to be applied by a constant voltage, the one of the first driving electrodes is configured to be applied by a first driving voltage, the one of the second driving electrodes is configured to be applied by the constant voltage, and the one of the adjusting electrodes is configured to be applied by the first driving voltage.

In an embodiment of the invention, the optoelectronic device further includes first alignment layer located between the display medium and the first substrate and a second alignment layer located between the display medium and the second substrate, in which the alignment-direction of the first alignment layer and the alignment-direction of the second alignment layer are staggered to each other.

In an embodiment of the invention, the display medium is a plurality of twisted nematic liquid crystal molecules.

In an embodiment of the invention, the display medium is a plurality of negative-type liquid crystal molecules.

In an embodiment of the invention, the optoelectronic device further includes a color filter layer located between the first substrate and the display medium or between the second substrate and the display medium, in which the color filter layer includes a plurality of color patterns, and each of the color patterns is respectively disposed in an area where a light adjusting unit is located in.

In an embodiment of the invention, the color patterns include a plurality of red patterns, a plurality of green patterns and a plurality of blue patterns, a portion of the display medium overlapped with the red patterns has a first thickness, a portion of the display medium overlapped with the green patterns has a second thickness, a portion of the display medium overlapped with the blue patterns has a third thickness, and the first thickness is greater than the second thickness and the second thickness is greater than the third thickness.

Based on the description above, in the optoelectronic device of the invention, the normal projections of one of the first driving electrodes, one of the adjusting electrodes and one of the second driving electrodes on the second substrate are sequentially arranged between two adjacent ones of the common electrodes so as to form a light-adjusting unit. Each of the above-mentioned light-adjusting units can be divided into two or more sub-pixels. In the embodiments of the invention, each of the sub-pixels guides the light to a specific direction to achieve the stereoscopic displaying function or the function to adjust the light emitting direction.

In order to make the features and advantages of the present invention more comprehensible, the present invention is further described in detail in the following with reference to the embodiments and the accompanying drawings.

### BRIEF DESCRIPTION OF THE DRAWINGS

FIG. 1 is a cross-sectional diagram of an optoelectronic device according to an embodiment of the invention.

FIG. 2 is a top-view diagram of the first driving electrodes, the second driving electrodes, the common electrodes and the adjusting electrodes in an optoelectronic device according to an embodiment of the invention.

FIG. 3 illustrates an arrangement of the positive-type liquid crystals in a light-adjusting unit of an optoelectronic device according to an embodiment of the invention.

FIG. 4 illustrates an arrangement of the negative-type liquid crystals in a light-adjusting unit of an optoelectronic device according to an embodiment of the invention.

FIG. 5 is a cross-sectional diagram of an optoelectronic device according to another embodiment of the invention.

FIG. 6 is a top-view diagram of the first driving electrodes, the second driving electrodes, the common electrodes and the adjusting electrodes in an optoelectronic device according to another embodiment of the invention.

FIG. 7 illustrates the relationship between the light intensity of a light passing through the light-adjusting units of FIG. 5 and the voltages applying to the light-adjusting units.

FIG. 8 is a cross-sectional diagram of an optoelectronic device according to yet another embodiment of the invention.

FIG. 9 illustrates the relationship between the light intensity of a light passing through the light-adjusting units of FIG. 8 and the voltages allying to the light-adjusting units.

FIGS. 10 and 11 show relationships between the thickness of the display medium and the contrast ratio of an optoelectronic device according to an embodiment of the invention.

FIGS. 12 and 13 show relationships between the thicknesses of the display medium and the cross talk ratios of an optoelectronic device according to an embodiment of the invention.

FIG. 14 shows the contrast ratio, the twisted angle and the thickness of the display medium in the experiment 1 of table 2.

FIG. 15 shows the cross talk ratio, the twisted angle and the thickness of the display medium in the experiment 1 of table 2.

FIG. 16 shows the contrast ratio, the twisted angle and the thickness of the display medium in the experiment 2 of table 2.

FIG. 17 shows the cross talk ratio, the twisted angle and the thickness of the display medium in the experiment 2 of table 2.

### DESCRIPTION OF THE EMBODIMENTS

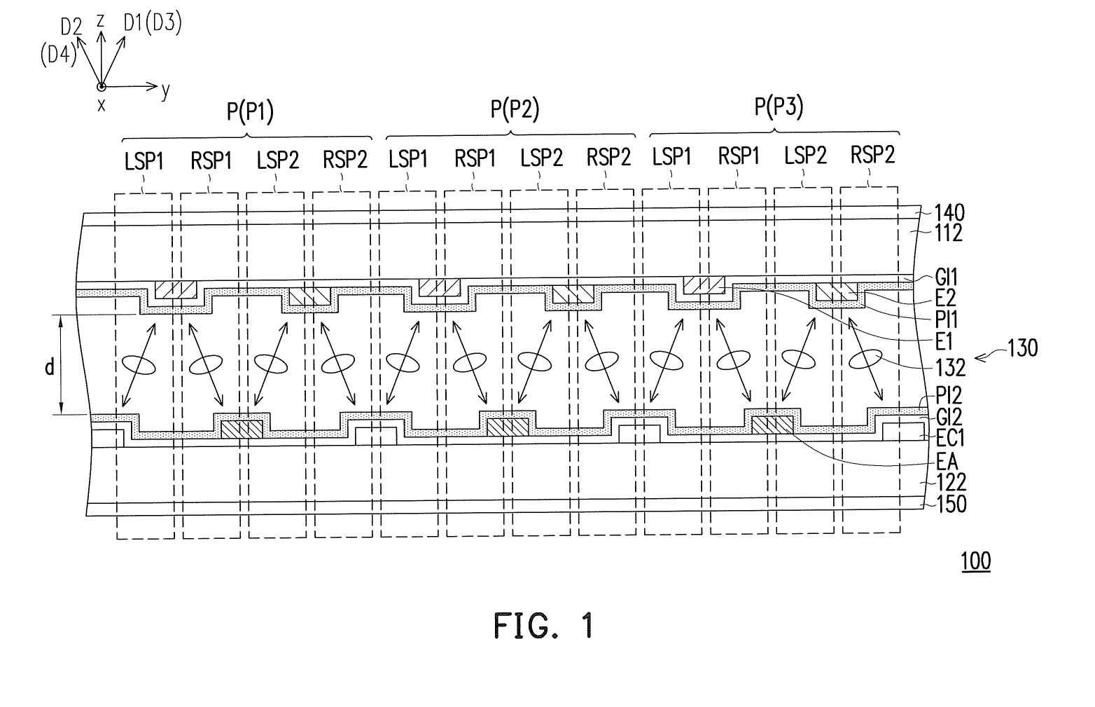

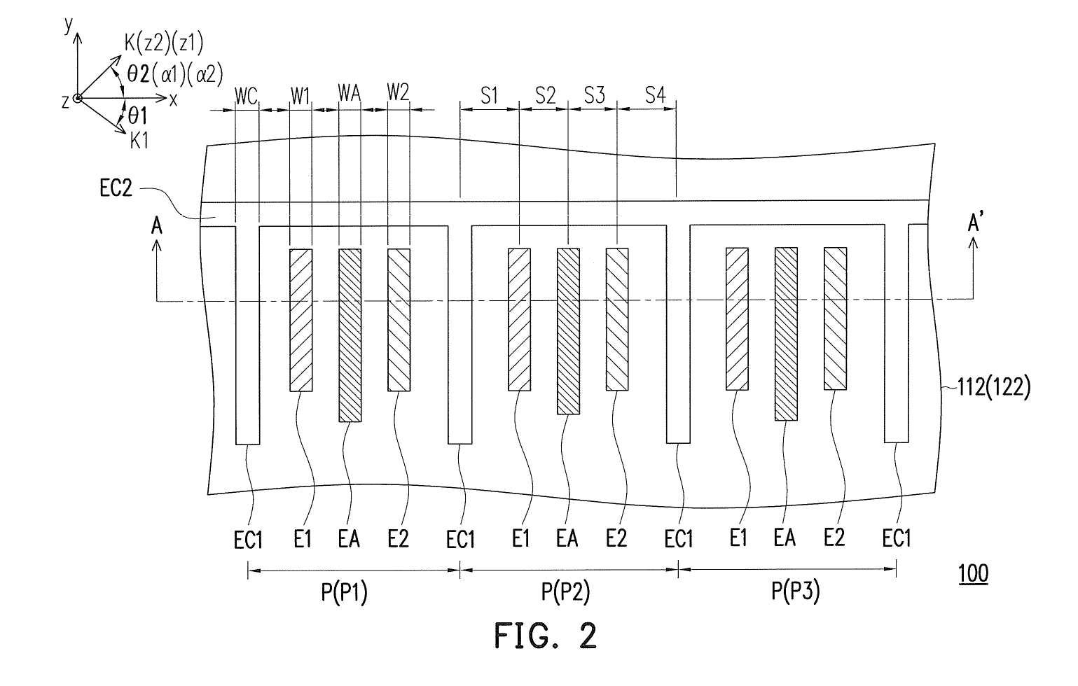

FIG. 1 is a cross-sectional diagram of an optoelectronic device according to an embodiment of the invention and FIG. 2 is a top-view diagram of the first driving electrodes, the second driving electrodes, the common electrodes and the adjusting electrodes in an optoelectronic device according to an embodiment of the invention. Specifically, FIG. 1 is made along the line A-A′ of FIG. 2. Referring to FIGS. 1 and 2, an optoelectronic device 100 includes a first substrate 112, a second substrate 122 opposite to the first substrate 112, a display medium 130 located between the first substrate 112 and the second substrate 122, a plurality of first driving electrodes E1 located between the display medium 130 and the first substrate 112, a plurality of second driving electrodes E2 located between display medium 130 and the first substrate 112, a plurality of common electrodes EC1 located between the display medium 130 and the second substrate 122 and a plurality of adjusting electrodes EA located between the display medium 130 and the second substrate 122. The first driving electrodes E1 and the second driving electrodes E2 are arranged alternately.

As shown by FIG. 1, in the embodiment, the first driving electrodes E1 and the second driving electrodes E2 can respectively be made of different film layers. In more details, a first insulation layer GI1 is disposed between the first driving electrodes E1 and the second driving electrodes E2, which the invention is not limited to. In an appropriate design of the electrode pattern, the first driving electrodes E1 and the second driving electrodes E2 can be made of a same film layer.

In the embodiment, viewed in the direction z perpendicular to the first substrate 112, the first driving electrodes E1 and the second driving electrodes E2 can be separated from each other as shown by FIG. 2, which the invention is not limited to and depends on the application of the optoelectronic device 100. The first driving electrodes E1 can be connected to the second driving electrodes E2 through other parts in other embodiments. In addition, in the embodiment, the first driving electrodes E1 and the second driving electrodes E2 can respectively be in straight-stripe shape, which the invention is not limited to. In fact, the first driving electrodes E1 and the second driving electrodes E2 can have other shapes depending on the real requirement.

Referring to FIGS. 1 and 2 again, the common electrodes EC1 and the adjusting electrodes EA are arranged alternately. The common electrodes EC1 and the adjusting electrodes EA are insulated from each other, and the first driving electrodes E1 and the second driving electrodes E2 are insulated from each other. In the embodiment, all the common electrodes EC1 can be electrically connected to each other so as to receive a same electrical level. In more details, as shown by FIG. 2, all the common electrodes EC1 are directly connected to a same conductor EC2 to be electrically connected to each other. The conductor EC2 and the common electrodes EC1 can be made a same film layer or respectively different film layers.

In the embodiment, the common electrodes EC1 and the adjusting electrodes EA respectively belong to different film layers. A second insulation layer GI2 can be employed and disposed between the common electrodes EC1 and the adjusting electrodes EA, which the invention is not limited to. In other embodiments, by an appropriate electrode pattern design, the common electrodes EC1 and the adjusting electrodes EA can belong to a same film layer. The common electrodes EC1 and the adjusting electrodes EA in the embodiment are in straight-stripe shape, which the invention is not limited to. In fact, the common electrodes EC1 and the adjusting electrodes EA can have other shapes depending on the real requirement.

It should be noted that, as shown by FIG. 2, the normal projections of one of the first driving electrodes E1, one of the adjusting electrodes EA and one of the second driving electrodes E2 on the second substrate 122 are sequentially arranged between two adjacent ones of the common electrodes EC1. The above-mentioned one first driving electrode E1, one adjusting electrode EA, one second driving electrodes E2 and adjacent two common electrodes EC1 together form a light-adjusting unit P. In the embodiment, the width WC of every common electrode EC1, the width W1 of every first driving electrode E1, the width WA of every adjusting electrode EA and the width W2 in each of the light-adjusting units P can be the same. In the light-adjusting unit P, the interval S1 between the common electrode EC1 and the first driving electrode E1 adjacent to the common electrode EC1, the interval S2 between the first driving electrode E1 and the adjusting electrode EA, the interval S3 between the adjusting electrode EA and the second driving electrode E2 and the interval S4 between the second driving electrode E2 and another common electrode EC1 adjacent to the second driving electrode E2 can be the same, which the invention is not limited to, and wherein the values of WC, W1, WA, WC, S1, S2, S3 and S4 depend on the real requirement.

In the embodiment, as shown by FIG. 1, each light-adjusting unit P can be divided into a first left sub-pixel LSP1, a first right sub-pixel RSP1, a second left sub-pixel LSP2 and a second right sub-pixel RSP2. The second left sub-pixel LSP2 is located between the first driving electrode E1 and one common electrode EC1 adjacent to the first driving electrodes E1 all belonging to the above-mentioned light-adjusting unit P; the first right sub-pixel RSP1 is located between the first driving electrode E1 and the adjusting electrode EA all belonging to the above-mentioned light-adjusting unit P; the second left sub-pixel LSP2 is located between the adjusting electrode EA and the second driving electrode E2 all belonging to the above-mentioned light-adjusting unit P; and the second right sub-pixel RSP2 is located between the second driving electrode E2 and another common electrode EC1 adjacent to the second driving electrode E2 all belonging to the above-mentioned light-adjusting unit P. In this way, each of the light-adjusting units P is divided into more than two sub-pixels. Due to such construction, i.e., each of the light-adjusting units P is divided into more than two sub-pixels, each of the light-adjusting units P can precisely guide the light to a specific direction to make the optoelectronic device 100 achieving the required light-adjusting effect.

In the embodiment, the optoelectronic device 100 is applicable to the display field serving to display frames and the light-adjusting unit P can be considered as a pixel unit. For example, the optoelectronic device 100 can serve as a multi-view display such as a dual-view display for vehicle or a stereoscopic display, which the invention is not limited to. The invention does not limit the application ways of the optoelectronic device 100. In other embodiments, the optoelectronic device 100 can serve as a light-path adjusting device, wherein the light-path adjusting device can replace the optoelectronic device in parallax barrier type or the optoelectronic device in lenticular lens type in the conventional design. Several examples are described in following to indicate the operations of the optoelectronic device 100 serving as a multi-view display such as a dual-view display, stereoscopic display and a light-path adjusting device.

Referring to FIG. 1, in each light-adjusting unit P, the voltage difference between the first driving electrode E1 and the common electrode EC1 adjacent to the first driving electrode E1 can produce a first electrical field parallel to the connection direction D1 between the common electrodes EC1 and the first driving electrodes E1 so as to make the liquid crystal molecules 132 in the first left sub-pixel LSP1 arranged subject to the driving of the first electrical field. The voltage difference between the first driving electrode E1 and the adjusting electrode EA can produce a second electrical field parallel to the connection direction D2 between the first driving electrodes E1 and the adjusting electrode EA so as to make the liquid crystal molecules 132 in the first right sub-pixel RSP1 arranged subject to the driving of the second electrical field. The voltage difference between the adjusting electrode EA and the second driving electrode E2 can produce a third electrical field parallel to the connection direction D3 between the adjusting electrode EA and the second driving electrodes E2 so as to make the liquid crystal molecules 132 in the second left sub-pixel LSP2 arranged subject to the driving of the third electrical field. The voltage difference between the second driving electrode E2 and another common electrode EC1 adjacent to the second driving electrode E2 can produce a fourth electrical field parallel to the connection direction D4 between the second driving electrode E2 and the common electrode EC1 so as to make the liquid crystal molecules 132 in the second right sub-pixel RSP2 arranged subject to the driving of the fourth electrical field.

In the embodiment, the connection direction D3 between the adjusting electrode EA and the second driving electrodes E2 can be parallel to the connection direction D1 between the common electrodes EC1 and the first driving electrodes E1; the connection direction D4 between the second driving electrode E2 and the common electrode EC1 can be parallel to the connection direction D2 between the first driving electrodes E1 and the adjusting electrode EA. Thus, the first electrical field is roughly parallel to the third electrical field, while the second electrical field is roughly parallel to the fourth electrical field, which the invention is not limited to. In other applications, the connection directions D1 and D3 can be not parallel to each other, the connection directions D2 and D4 can be not parallel to each other, and the connection directions D1-D4 can be designed depending on the real requirement.

When the liquid crystal molecules 132 are negative-type liquid crystals, for example, twisted nematic liquid crystals, the liquid crystal molecules 132 in the first left sub-pixel LSP1, driven by the first electrical field, would make the long-axis thereof tilt to the vertical connection direction D1, and the liquid crystal molecules 132 in the second left sub-pixel LSP2, driven by the third electrical field, would make the long-axis thereof tilt to the vertical connection direction D3. Meanwhile, the liquid crystal molecules 132 in the first right sub-pixel RSP1, driven by the second electrical field, would make the long-axis thereof tilt to the vertical connection direction D2, and the liquid crystal molecules 132 in the second right sub-pixel RSP2, driven by the fourth electrical field, would make the long-axis thereof tilt to the vertical connection direction D4. At the time, based on the different tilting directions of the liquid crystal molecules 132, the light passing through the first right sub-pixel RSP1 and the light passing through the second right sub-pixel RSP2 travel towards different directions so as to define out at least two viewing domains.

If the left-eye and the right-eye of a same user are respectively located in different viewing domains, the optoelectronic device 100 at the time allows the light passing through the first left sub-pixel LSP1 and the second left sub-pixel LSP2 of each light-adjusting unit P carrying the left-eye frame, and allows the light passing through the first right sub-pixel RSP1 and the second right sub-pixel RSP2 of each light-adjusting unit P carrying the right-eye frame, so that once there is a parallax between the left-eye frame and the right-eye frame, the user at the time can see stereoscopic images. For watching the planar, two dimensional, images, the left-eye frame and the right-eye frame are a same frame by design. At the time, the optoelectronic device 100 can be disposed over the display panel so as to be applicable as a planar/stereoscopic display.

If two different users (for example, a driver and a passenger) are respectively located in two different viewing domains, the optoelectronic device 100 at the time can adjust the driving electrical fields of the first right sub-pixel RSP1 and the second right sub-pixel RSP2 of each light-adjusting unit P so that the first right sub-pixel RSP1 and the second right sub-pixel RSP2 in one viewing domain can be used to display the first frame. Simultaneously, the optoelectronic device 100 at the time can adjust the driving electrical fields of the first left sub-pixel LSP1 and the second left sub-pixel LSP2 of each light-adjusting unit P so that the first left sub-pixel LSP1 and the second left sub-pixel LSP2 in another viewing domain can be used to display the second frame. In this way, the two users can respectively watch the different first frame and second frame (such as the navigation frame and the movie frame). At the time, the optoelectronic device 100 is applicable to a dual-view display.

Specifically, when the optoelectronic device 100 is used in a dual-view display, the common electrode EC1 is configured to be applied by the constant voltage VC, the first driving electrode E1 located between the two adjacent common electrodes EC1 is configured to be applied by the first driving voltage VR, the second driving electrode E2 located between the two adjacent common electrodes EC1 is configured to be applied by the second driving voltage VL and the adjusting electrode EA located between the two adjacent common electrodes EC1 is configured to be applied by the adjusting voltage VA. If the second driving voltage VL is equal to the constant voltage VC by design and the adjusting voltage VA is the same as the first driving voltage VR by design, the light-adjusting unit P can produce electrical fields roughly parallel to the connection directions D1 and D3 therein so as to make the most light passing through the light-adjusting unit P travels to one of the viewing domains. In this way, the dual-view display can be switched to a mono-view display available for the user located at one of the viewing domains to use.

The optoelectronic device 100 is applicable to a dual-view display or a stereoscopic display, which can be achieved by adjusting the relative positions between the common electrode EC1, the first driving electrode E1, the second driving electrode E2 and the adjusting electrode EA. People skilled in the art can implement the design according to the disclosure of the specification, which is omitted to describe.

In other embodiments, the optoelectronic device 100 can serve as a light-path adjusting device as well. In more details, in each of the light-adjusting units P, the voltage difference between the first driving electrode E1 and a common electrode EC1 adjacent to the first driving electrodes E1, the voltage difference between the first driving electrode E1 and the adjusting electrode EA, the voltage difference between the adjusting electrode EA and the second driving electrode E2 and the voltage difference between the second driving electrode E2 and another common electrode EC1 adjacent to the second driving electrode E2 can be specified to be the same. At the time, the light respectively passing through the first left sub-pixel LSP1, the first right sub-pixel RSP1, the second left sub-pixel LSP2 and the second right sub-pixel RSP2 of each light-adjusting unit P would travel towards a specific direction, while the relative intensities of the light passing these sub-pixels keep unchanged. At the time, the optoelectronic device 100 serves as a light-path adjusting device.

It should be noted that no matter what application the optoelectronic device 100 used in, in order to avoid the liquid crystal molecules 132 in the left sub-pixel and the right sub-pixel in each the light-adjusting unit P from mutual interferences, the adjusting voltage VA applying to the adjusting electrode EA can be designed properly to reduce the problem in the present embodiment. In more details, in a same light-adjusting unit P, the adjusting voltage VA is obtained by a sum of the first driving voltage VR and the second driving voltage VL minus the constant voltage VC by design. At the time, the voltage difference applying to the liquid crystal molecules 132 located at the first left sub-pixel LSP1 is the difference value, |VR−VC|, between the first driving voltage VR and the constant voltage VC; the voltage difference applying to the liquid crystal molecules 132 located at the second left sub-pixel LSP2 is the difference value, [|VL−VA|=|VL−(VR+VL−VC)|=|VR−VC|], between the first driving voltage VR and the constant voltage VC; the voltage difference applying to the liquid crystal molecules 132 located at the first right sub-pixel RSP1 is the difference value, [|VR−VA|=|VR−(VR+VL−VC)|=|VL−VC|], between the second driving voltage VL and the constant voltage VC; the voltage difference applying to the liquid crystal molecules 132 located at the second right sub-pixel RSP2 is the difference value, |VL−VC|, between the second driving voltage VL and the constant voltage VC. In short, by adjusting the level of the adjusting voltage VA, the voltage difference the liquid crystal molecules 132 located at the first right sub-pixel RSP1 (or the first left sub-pixel LSP1) are subject to and the voltage difference the liquid crystal molecules 132 located at the second right sub-pixel RSP2 (or the second left sub-pixel LSP2) are subject to are the same so that the adjacent sub-pixels are unlikely interfered by each other.

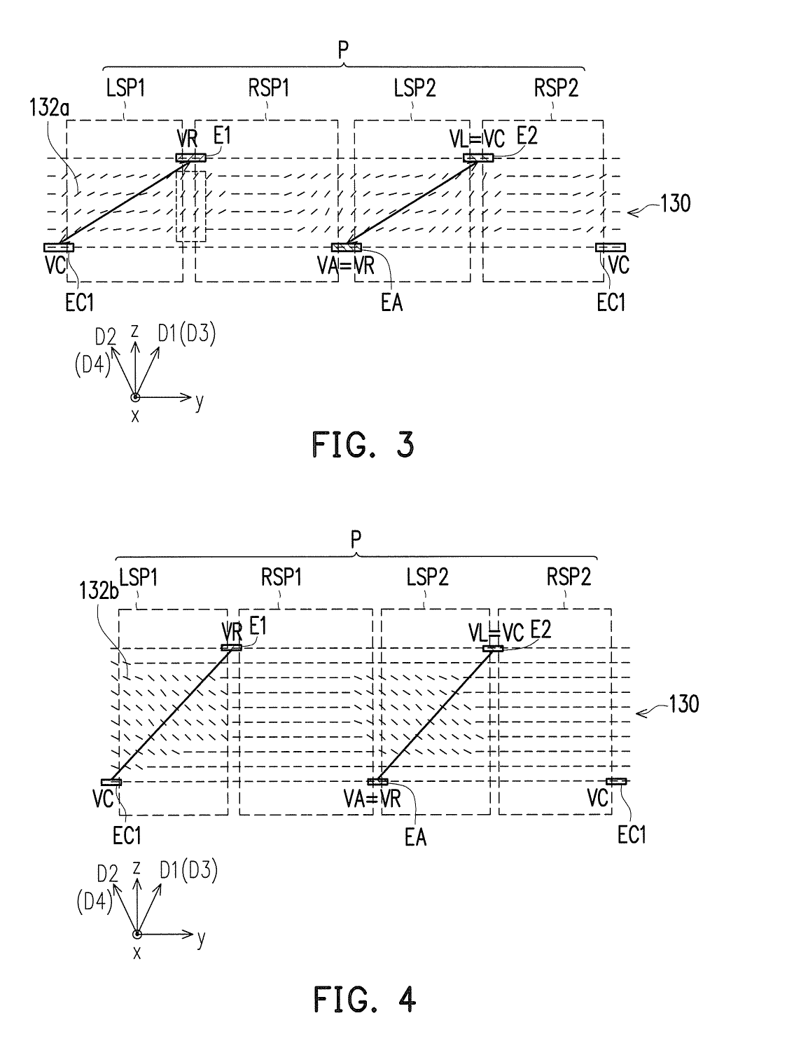

In the embodiment, the display medium 130 can be a plurality of liquid crystal molecules 132. Moreover, the liquid crystal molecules 132 can be the negative-type liquid crystals to achieve better effect for the optoelectronic device 100 to adjust the light transmitting direction, referring to FIGS. 3 and 4 in following. FIG. 3 illustrates an arrangement of the positive-type liquid crystals in a light-adjusting unit of an optoelectronic device according to an embodiment of the invention and FIG. 4 illustrates an arrangement of the negative-type liquid crystals in a light-adjusting unit of an optoelectronic device according to an embodiment of the invention. Table 1 gives out the physical parameters of the positive-type liquid crystal molecules 132a of FIG. 3 and the negative-type liquid crystal molecules 132b of FIG. 4.

TABLE 1

| | | Positive-type | Negative-type |
|---|---|---|---|
| | | Liquid Crystal | Liquid Crystal |
| | | Molecules | Molecules |
| Physical Parameters | Notations | 132a | 132b |
| Clearing Point | Tni | 58° C. | 100° C. |
| Optical Anisotropy | Δn | 0.2255 | 0.0437 |
| | nₑ | 1.7472 | 1.5183 |
| | nₒ | 1.5217 | 1.4746 |
| Dielectric Anisotropy | Δε | +14.1 | −4.8 |
| | ε⊥ | 5.2 | 3.3 |
| | ε∥ | 19.3 | 8.1 |
| Elastic Constants | K₁ | 11.1 pN | 14.9 pN |
| | K₃ | 17.1 pN | 15.2 pN |
| | K₃/K₁ | 1.54 | 1.02 |

Referring to FIG. 3, when the first driving electrode E1, the second driving electrode E2, the common electrode EC1 and the adjusting electrode EA in the light-adjusting unit P are respectively applied by the voltage values marked beside them, the long-axes of the most positive-type liquid crystal molecules 132a in the first left sub-pixel LSP1 and the second left sub-pixel LSP2 should be parallel to the connection directions D1 and D3 in theory. However in fact, as shown by FIG. 3, the long-axes of the most positive-type liquid crystal molecules 132a right under the first driving electrodes E1 and the second driving electrodes E2 may not be parallel to the connection directions D1 and D3, which causes the optoelectronic device 100 to produce light-leaking problem to affect the effect for the optoelectronic device 100 to adjust the light transmitting direction.

Referring to FIG. 4, when the first driving electrode E1, the second driving electrode E2, the common electrode EC1 and the adjusting electrode EA in the light-adjusting unit P are respectively applied by the voltage values marked beside them, the long-axes of the most negative-type liquid crystal molecules 132b in the first left sub-pixel LSP1 and the second left sub-pixel LSP2 should be perpendicular to the connection directions D1 and D3 in theory. At the time, the negative-type liquid crystal molecules 132b in the first left sub-pixel LSP1 and the second left sub-pixel LSP2 can make the light passing through the first left sub-pixel LSP1 and the second left sub-pixel LSP2 travel towards the specific direction. Comparing FIG. 4 with FIG. 3, when the display medium 130 selects the negative-type liquid crystal molecules 132b, the optoelectronic device 100 is unlikely to produce the light-leaking problem, which enhances the effect for the optoelectronic device 100 to adjust the light transmitting direction.

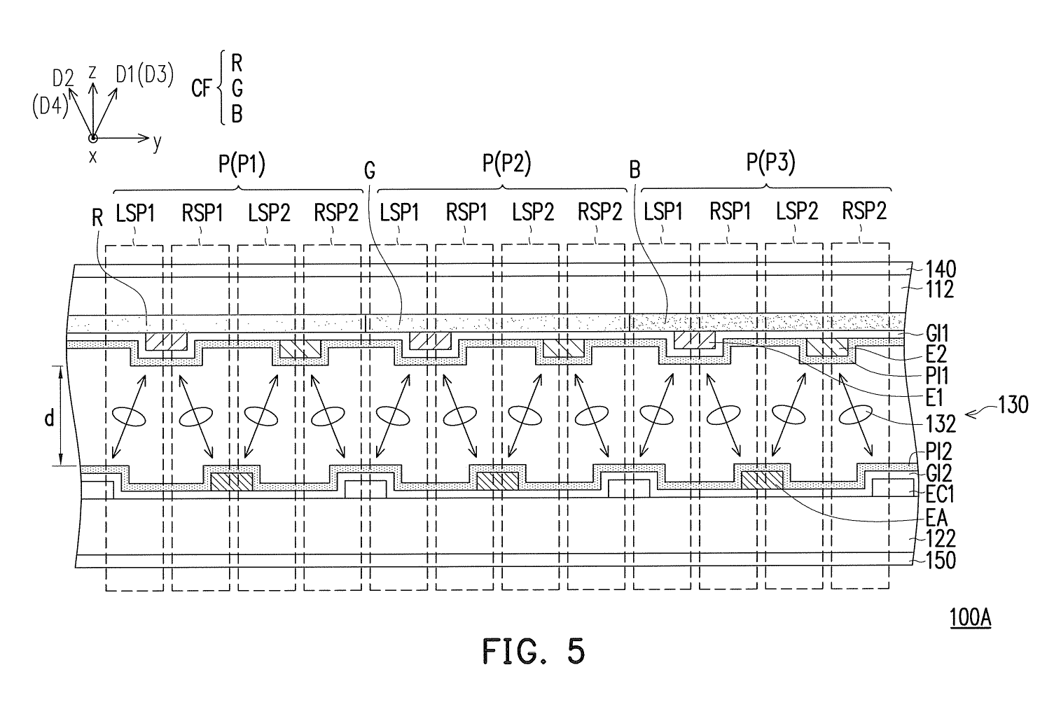

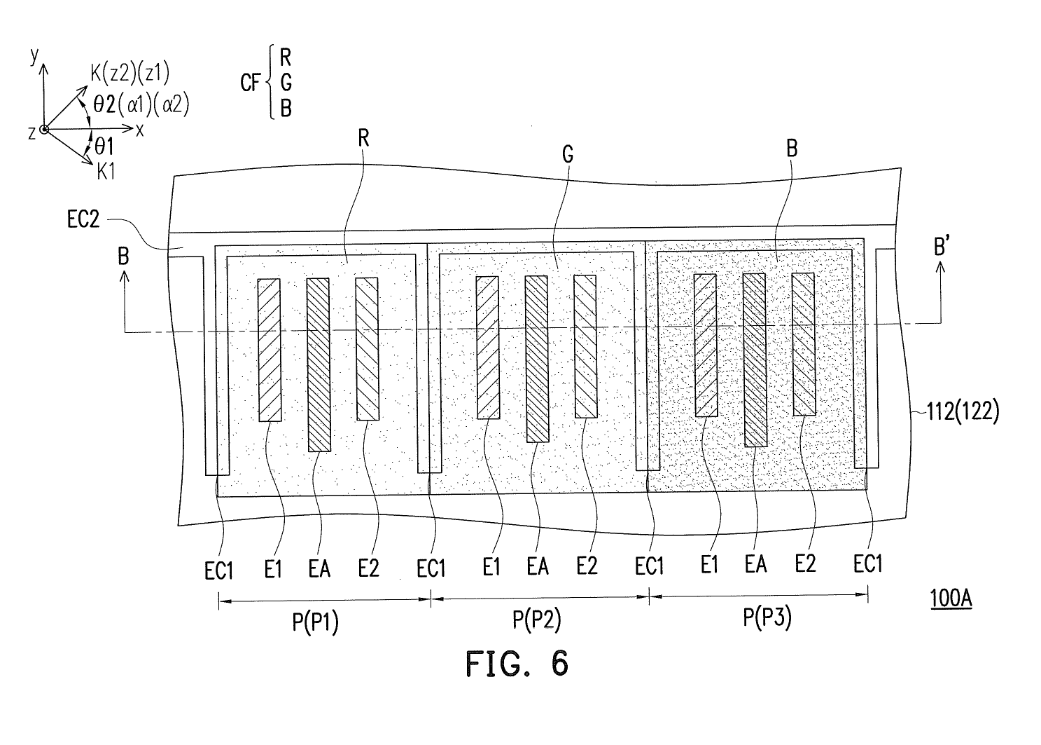

FIG. 5 is a cross-sectional diagram of an optoelectronic device according to another embodiment of the invention and FIG. 6 is a top-view diagram of the first driving electrodes, the second driving electrodes, the common electrodes and the adjusting electrodes in an optoelectronic device according to another embodiment of the invention, wherein FIG. 5 is made based on section line B-B′ in FIG. 6. Referring to FIGS. 5 and 6, the optoelectronic device 100A is similar to the optoelectronic device 100 and their same components are marked in the same notations. The difference of the optoelectronic device 100A from the optoelectronic device 100 rests in the optoelectronic device 100A further includes a color filter layer CF. The color filter layer CF is located between the first substrate 112 and the display medium 130. In an alternative embodiment, the color filter CF can be located between the second substrate 122 and the display medium 130. The color filter layer CF includes a plurality of color patterns R, G and B, and the color patterns R, G and B can be respectively disposed in areas where a plurality of light-adjusting units P1, P2 and P3 are located in. The color patterns R, G and B can be respectively a red pattern, a green pattern and a blue pattern, which the invention is not limited to. In other embodiments, the color patterns R, G and B can be other colors. The optoelectronic device 100A containing the color filter layer CF is able to display color frames. Moreover, as shown by FIG. 5, the optoelectronic device 100A further includes a first alignment layer PI1 located between the display medium 130 and the first substrate 112 and a second alignment layer PI2 located between the display medium 130 and the second substrate 122. As shown by FIG. 6, viewed in the direction z perpendicular to the first substrate 112, the alignment direction K1 of the first alignment layer PI1 and the alignment direction K2 of the second alignment layer PI2 can be intersected to each other. Referring to FIGS. 5 and 6 again, the optoelectronic device 100A can adopt a design of single liquid crystal gap, i.e., the thicknesses d of the display medium 130 in the optoelectronic device 100A are the same as each other.

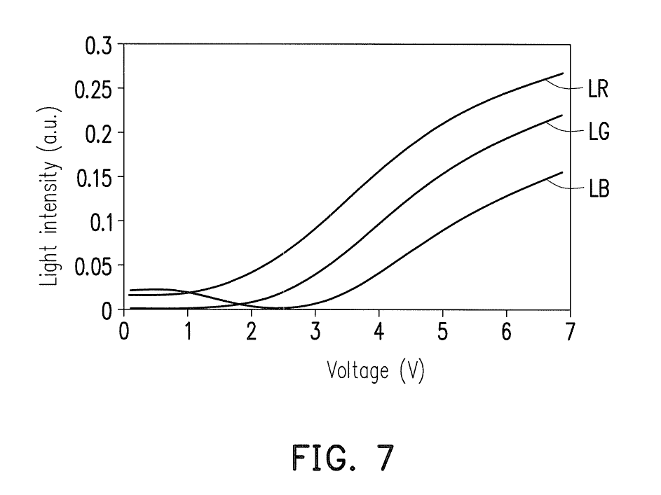

FIG. 7 illustrates the relationship between the light intensity of a light passing through the light-adjusting units of FIG. 5 and the voltages applying to the light-adjusting units, wherein the curve LR represents the relationship between the light intensity of the light passing through the light-adjusting unit P1 and the voltage applying to the light-adjusting unit P1, the curve LG represents the relationship between the light intensity of the light passing through the light-adjusting unit P2 and the voltage applying to the light-adjusting unit P2 and the curve LB represents the relationship between the light intensity of the light passing through the light-adjusting unit P3 and the voltage applying to the light-adjusting unit P3. It can be seen in FIG. 7, when the display medium 130 is a plurality of twisted nematic liquid crystal molecules and the alignment-direction K1 of the first alignment layer PI1 and the alignment-direction K2 of the second alignment layer PI2 are intersected to each other, the running trends of the curves LR, LG and LB are not close to each other, i.e., the relationship between the light intensity of the light passing through the color pattern R and the voltage applying to the light-adjusting unit P1, the relationship between the light intensity of the light passing through the color pattern G and the voltage applying to the light-adjusting unit P2 and the relationship between the light intensity of the light passing through the color pattern B and the voltage applying to the light-adjusting unit P3 are not similar to each other, and at the time, the optoelectronic device 100A has obvious color shift effect.

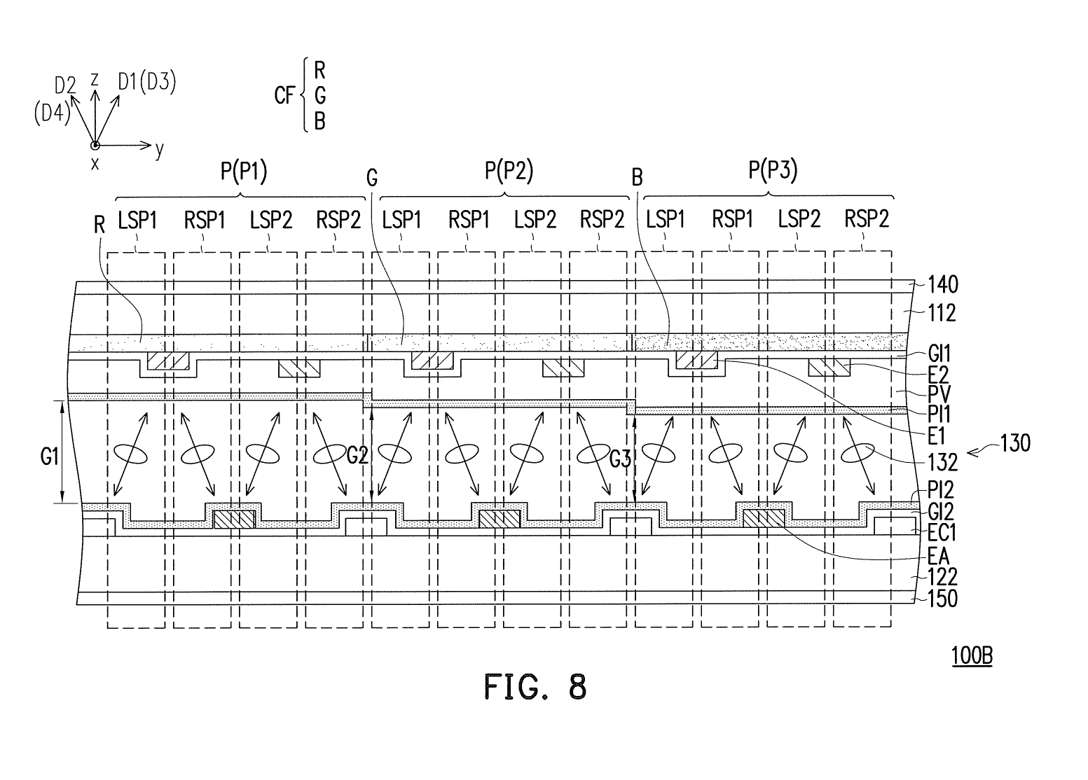

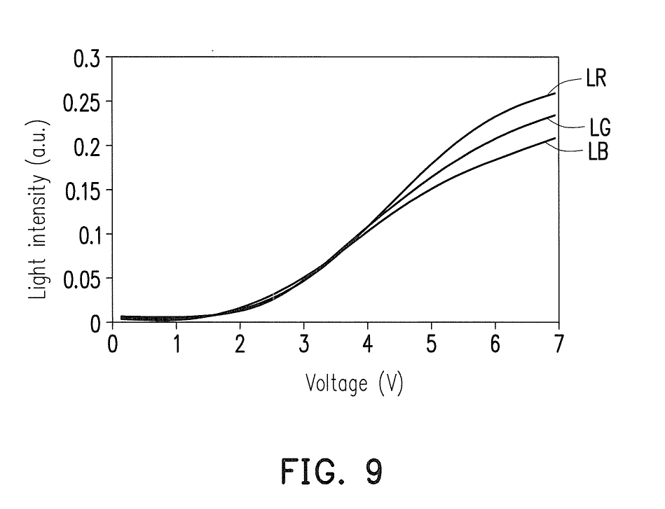

In order to further reduce the color shift problem, the optoelectronic device can adopt a design of multi cell gaps, referring to the following FIGS. 8 and 9. FIG. 8 is a cross-sectional diagram of an optoelectronic device according to yet another embodiment of the invention. Referring to FIG. 8, the optoelectronic device 100B is similar to the optoelectronic device 100A and their same components are marked in the same notations. The difference of the optoelectronic device 100B from the optoelectronic device 100A rests in, in the optoelectronic device 100B, the thickness of the partial display medium 130 overlapped with the red pattern R can be a first thickness G1, the thickness of the partial display medium 130 overlapped with the green pattern G can be a second thickness G2, and the thickness of the partial display medium 130 overlapped with the blue pattern B can be a third thickness G3. The first thickness G1 can be greater than the second thickness G2 and the second thickness G2 can be greater than the third thickness G3. The first thickness G1 is, for example, 13.7 μm; the second thickness G2 is, for example, 12 μm; the third thickness G3 is, for example, 9 μm.

FIG. 9 illustrates the relationship between the light intensity of a light passing through the light-adjusting units of FIG. 8 and the voltages allying to the light-adjusting units. The curve LR represents the relationship between the light intensity of the light passing through the light-adjusting unit P1 and the voltage applying to the light-adjusting unit P1, the curve LG represents the relationship between the light intensity of the light passing through the light-adjusting unit P2 and the voltage applying to the light-adjusting unit P2 and the curve LB represents the relationship between the light intensity of the light passing through the light-adjusting unit P3 and the voltage applying to the light-adjusting unit P3. It can be seen in FIG. 9, when the first thickness G1 is greater than the second thickness G2 and the second thickness G2 is greater than the third thickness G3 by design, the running trends of the curves LR, LG and LB are further similar to each other, i.e., the relationship between the light intensity of the light passing through the color pattern R and the voltage applying to the light-adjusting unit P1, the relationship between the light intensity of the light passing through the color pattern G and the voltage applying to the light-adjusting unit P2 and the relationship between the light intensity of the light passing through the color pattern B and the voltage applying to the light-adjusting unit P3 are more similar to each other, which means when the first thickness G1 is greater than the second thickness G2 and the second thickness G2 can is greater than the third thickness G3, the color shift effect of the optoelectronic device 100B can be further reduced.

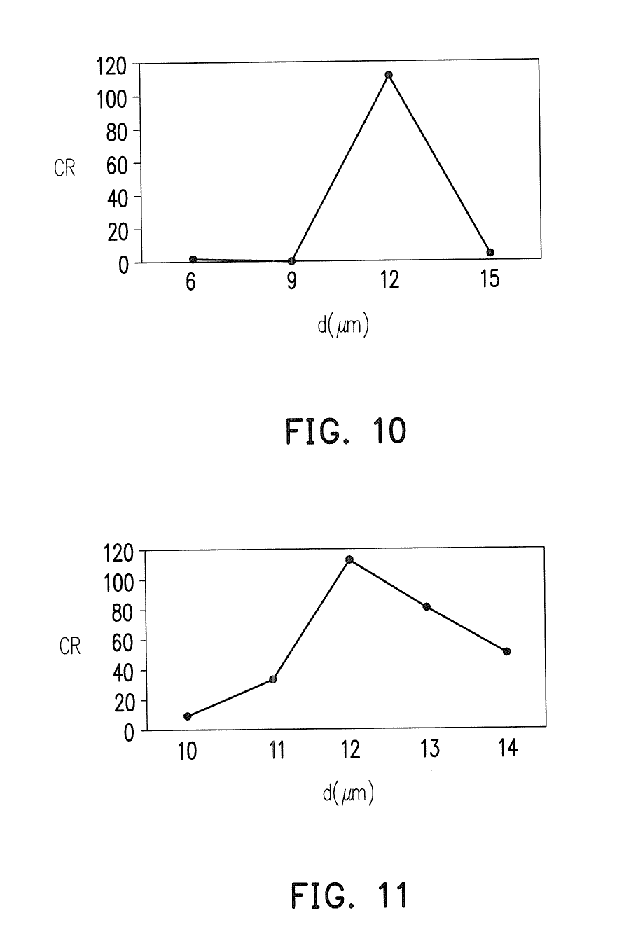

In addition, by properly specifying the thickness d of the display medium 130 (as shown by FIG. 5), the alignment direction K1 of the first alignment layer PI1 (as shown by FIG. 6) and the alignment direction K2 of the second alignment layer PI2 (as shown by FIG. 6), the direction Z1 of penetrating axis of an upper polarizer 140 (as shown by FIG. 6) and the direction Z2 of penetrating axis of a lower polarizer 150 (as shown by FIG. 6) through design, the optical characteristic of the optoelectronic device 100A gets optimized, referring to following FIGS. 10-17.

FIGS. 10 and 11 show relationships between the thickness of the display medium and the contrast ratio (CR) of an optoelectronic device according to an embodiment of the invention. The CR of the optoelectronic device 100A is defined as following: CR==(T_{Max|Intended}/T_{Min|Intended}), wherein T_{Max|Intended} represents the maximal transmittance when the light-adjusting unit P of the optoelectronic device 100A is driven, and T_{Min|Intended} represents the minimal transmittance when the light-adjusting unit P of the optoelectronic device 100A is driven. The larger CR means a better performance of the optoelectronic device 100A. It can be seen from FIGS. 10 and 11, in the case that the display medium 130 adopts the negative-type liquid crystal molecules 132b of Tab. 1, the included angle between the alignment direction K1 of the first alignment layer PI1 and the alignment direction K2 of the second alignment layer PI2 is 90°, and both the direction Z1 of penetrating axis of the upper polaroid 140 and the direction Z1 of penetrating axis of the lower polaroid 150 are parallel to the alignment direction K2 of the second alignment layer PI2, the optoelectronic device 100A has high CR when the thickness of the display medium 130 is 12 μm.

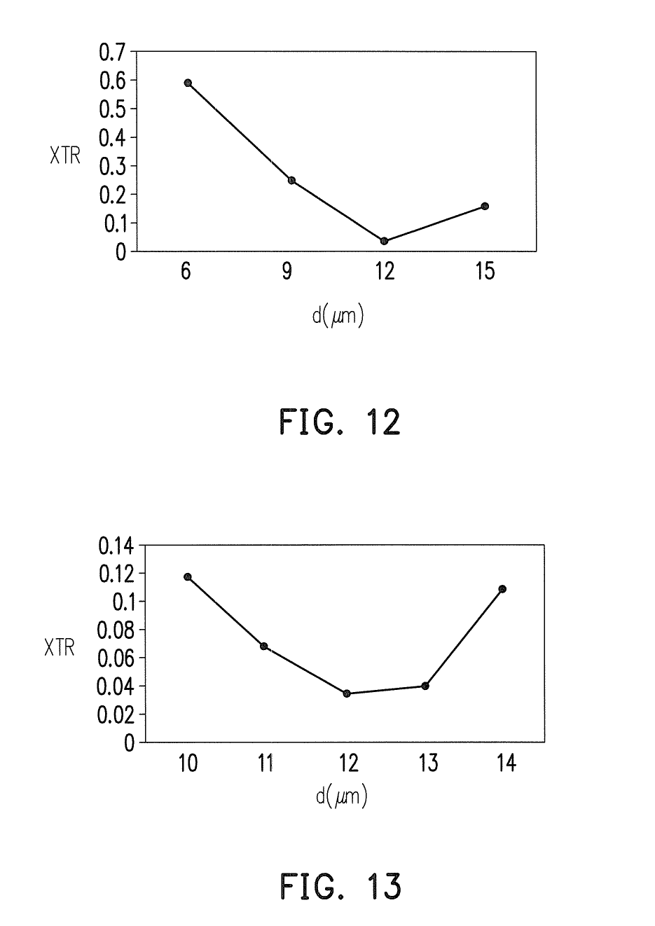

FIGS. 12 and 13 show relationships between the thicknesses of the display medium and the cross talk ratios of an optoelectronic device according to an embodiment of the invention. The cross talk ratio XTR of the optoelectronic device 100A is defined as following: XTR=(T_{Max|un-Intended}/T_{Max|Intended}), wherein T_{Max|un-Intended} is the maximal transmittance when the light-adjusting unit P of the optoelectronic device 100A is not driven, and T_{Max|Intended} is the maximal transmittance when the light-adjusting unit P of the optoelectronic device 100A is driven. A smaller cross talk ratio XTR means the better performance of the optoelectronic device 100A. It can be seen from FIGS. 12 and 13, in the case that the display medium 130 adopts the negative-type liquid crystal molecules 132b of Tab 1, the included angle between the alignment direction K1 of the first alignment layer PI1 and the alignment direction K2 of the second alignment layer PI2 is 90°, and both the direction Z1 of penetrating axis of the upper polaroid 140 and the direction Z2 of penetrating axis of the lower polaroid 150 are parallel to the alignment direction K2 of the second alignment layer PI2, the optoelectronic device 100A has low XTR when the thickness of the display medium 130 is 12 μm.

Table 2 gives out an experiment design parameters including the alignment direction of the alignment layer and the direction of the penetrating axis of the Polarizer. Referring to Table 2, α1 represents the included angle between the direction Z1 of penetrating axis of the upper polarizer 140 in FIG. 6 and the direction x, α2 represents the included angle between the direction Z2 of penetrating axis of the lower polarizer 150 in FIG. 6 and the direction x, θ1 represents the included angle between the alignment direction K1 of the first alignment layer PI1 in FIG. 6 and the direction x, and 02 represents the included angle between the alignment direction K2 of the second alignment layer P12 in FIG. 6 and the direction x, wherein d represents the thickness d of the display medium 130 and (θ2−θ1) represents a twisted angle.

TABLE 2

| | Experiment 1 | Experiment 2 |
|---|---|---|
| | (θ2-θ1) | (θ2-θ1) |
| d | α2/θ2/θ1/α1 | α2/θ2/θ1/α1 |
| (unit: μm) | (unit: °) | (unit: °) |
| 10 | 90 | 90 |
| | 45/45/-45/45 | 45/45/-45/45 |
| 11 | 88 | 88 |
| | 45/44/-44/45 | 44/44/-44/46 |
| 12 | 86 | 86 |
| | 45/43/-43/45 | 43/43/-43/47 |
| 13 | 84 | 84 |
| | 45/42/-42/45 | 42/42/-42/48 |
| 14 | 82 | 82 |
| | 45/41/-41/45 | 41/41/-41/49 |
| | 80 | 80 |
| | 45/40/-40/45 | 40/40/-40/50 |

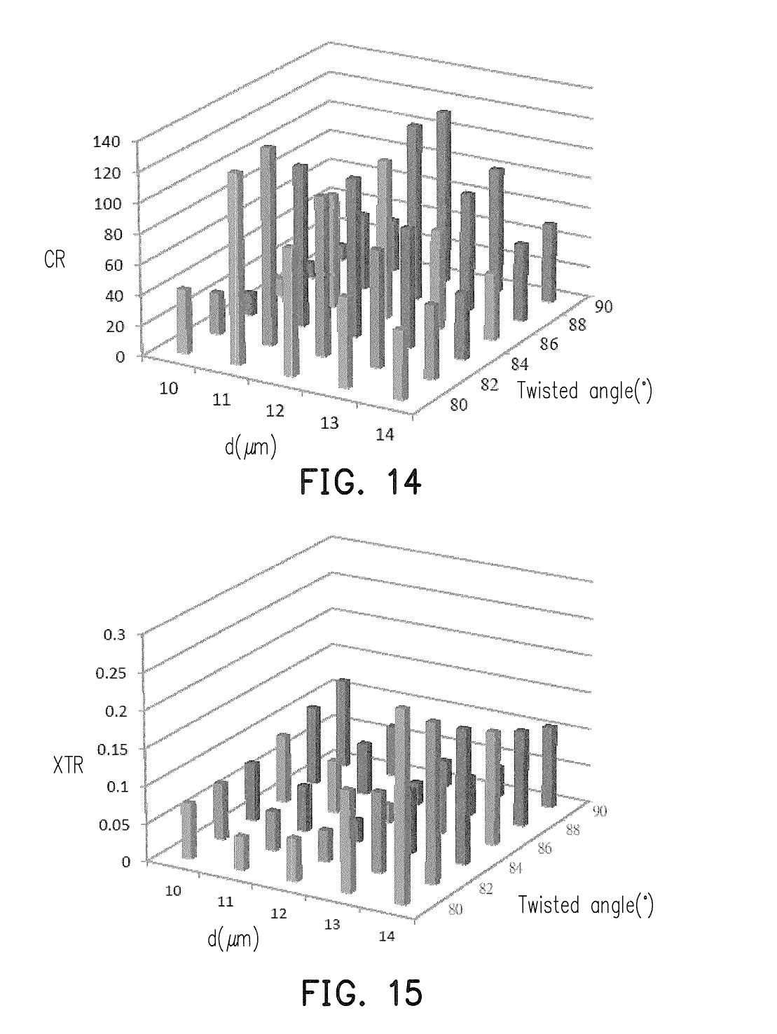

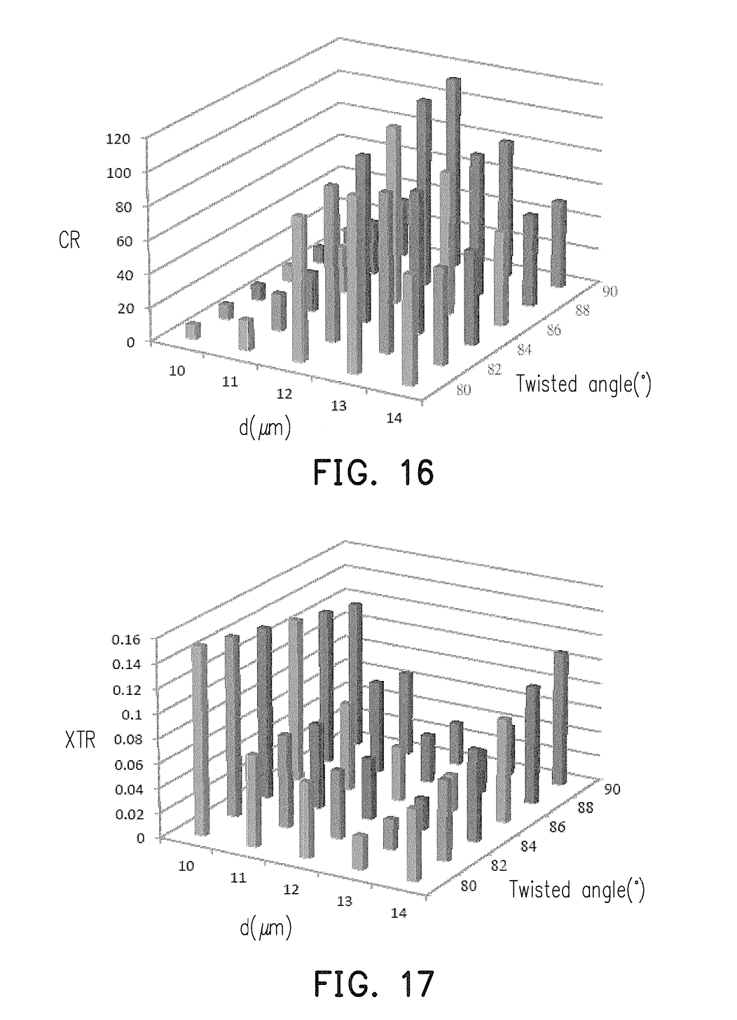

FIG. 14 shows the contrast ratio, the twisted angle and the thickness of the display medium in the experiment 1 of table 2, FIG. 15 shows the cross talk ratio, the twisted angle and the thickness of the display medium in the experiment 1 of table 2, FIG. 16 shows the contrast ratio, the twisted angle and the thickness of the display medium in the experiment 2 of table 2 and FIG. 17 shows the cross talk ratio, the twisted angle and the thickness of the display medium in the experiment 2 of table 2. It can be seen in FIGS. 14-17, when the thickness d of the display medium 130 is 12 μm, the included angle between the alignment direction K1 of the first alignment layer PI1 and the alignment direction K2 of the second alignment layer PI2 is 90°, and both the direction Z1 of penetrating axis of the upper polaroid 140 and the direction Z2 of penetrating axis of the lower polaroid 150 are parallel to the alignment direction K2 of the second alignment layer PI2, the optoelectronic device 100A has high CR and low XTR.

In summary, in the optoelectronic device of an embodiment of the invention, the normal projections of one of the first driving electrodes, one of the adjusting electrodes and one of the second driving electrodes on the second substrate are sequentially arranged between two adjacent ones of the common electrodes so as to form a light-adjusting unit. The adjusting electrode disposed between the first driving electrode and the second driving electrode can make each light-adjusting unit divided into two or more sub-pixels so that each the light-adjusting unit can guide the light to a specific direction to achieve the effect of adjusting the light. In addition, by properly specify the level of the voltage applying to the adjusting electrode, the liquid crystal molecules located at the left sub-pixel and the right sub-pixel are unlikely interfered by each other so as to achieve a good light-adjusting effect of the optoelectronic device.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An optoelectronic device, comprising:
a first substrate;
a second substrate, opposite to the first substrate;
a display medium, located between the first substrate and the second substrate;
a plurality of first driving electrodes, located between the display medium and the first substrate;
a plurality of second driving electrodes, located between the display medium and the first substrate, wherein the first driving electrodes and the second driving electrodes are arranged alternately;
a plurality of common electrodes, located between the display medium and the second substrate; and
a plurality of adjusting electrodes, located between the display medium and the second substrate, wherein the adjusting electrodes and the common electrodes are arranged alternately, the common electrodes and the adjusting electrodes are electrically insulated from each other, the first driving electrodes and the second driving electrodes are electrically insulated from each other, and normal projections of one of the first driving electrodes, one of the adjusting electrodes and one of the second driving electrodes on the second substrate are sequentially arranged between two adjacent ones of the common electrodes.

2. The optoelectronic device as claimed in claim 1, wherein the two adjacent common electrodes, the one of the first driving electrodes, the one of the adjusting electrodes and the one of the second driving electrodes together form a light-adjusting unit.

3. The optoelectronic device as claimed in claim 1, wherein the adjacent two common electrodes are configured to be applied by a constant voltage, the one of the first driving electrodes is configured to be applied by a first driving voltage, the one of the second driving electrodes is configured to be applied by a second driving voltage, the one of the adjusting electrodes is configured to be applied by an adjusting voltage, and the adjusting voltage is obtained by the sum of the first driving voltage and the second driving voltage minus the constant voltage.

4. The optoelectronic device as claimed in claim 1, wherein the adjacent two common electrodes are configured to be applied by a constant voltage, the one of the first driving electrodes is configured to be applied by a first driving voltage, the one of the second driving electrodes is configured to be applied by a constant voltage, and the one of the adjusting electrodes is configured to be applied by the first driving voltage.

5. The optoelectronic device as claimed in claim 1, further comprising:
a first alignment layer, located between the display medium and the first substrate; and
a second alignment layer, located between the display medium and the second substrate, wherein an alignment-direction of the first alignment layer and an alignment-direction of the second alignment layer are intersected to each other.

6. The optoelectronic device as claimed in claim 1, wherein the display medium is a plurality of twisted nematic liquid crystal molecules.

7. The optoelectronic device as claimed in claim 1, wherein the display medium is a plurality of negative-type liquid crystal molecules.

8. The optoelectronic device as claimed in claim 2, further comprising:
a color filter layer, located between the first substrate and the display medium or between the second substrate and the display medium, wherein the color filter layer comprises a plurality of color patterns, and each of the color patterns is respectively disposed in an area where the light-adjusting unit is located in.

9. The optoelectronic device as claimed in claim 8, wherein the color patterns comprise a plurality of red patterns, a plurality of green patterns and a plurality of blue patterns, a portion of the display medium overlapped with the red patterns has a first thickness, a portion of the display medium overlapped with the green patterns has a second thickness, a portion of the display medium overlapped with the blue patterns has a third thickness, and the first thickness is greater than the second thickness and the second thickness is greater than the third thickness.
